(19) United States
(12) Patent Application Publication
(10) Pub. No.: US 2023/0214831 A1
(43) Pub. Date: Jul. 6, 2023

(54) DOCUMENTATION RECORD VERIFICATION

(71) Applicant: Ramp Business Corporation, New York, NY (US)

(72) Inventors: Calvin Jun-Gong Lee, Weehawken, NJ (US); Geoffrey Jacques Charles, Brooklyn, NY (US); Diego D. Zaks Barrios, New York, NY (US); Jared Robert Wasserman, New York, NY (US)

(21) Appl. No.: 17/566,617

(22) Filed: Dec. 30, 2021

(51) Int. Cl. G06Q 20/40; G06N 20/00; G06F 40/205; G06F 40/295; G06F 40/258

(52) U.S. Cl. CPC G06Q 20/401; G06N 20/00; G06F 40/205; G06F 40/295; G06F 40/258

(57) ABSTRACT

A system for verifying transactions includes a computing server configured to identify an unverified transaction among real-time transactions that the computing server processes on behalf of an organization client. The computing server receives a forward of a documentation record from an end user through a communication channel (e.g., receiving an image of a paper receipt of a transaction without prompting the end user to provide the receipt). The computing server parses the documentation record to extract information (e.g., a transaction date) to verify the unverified transaction. If the information from the parsed documentation record matches corresponding fields of the unverified transaction, the computing server may display a user interface indicating that the transaction was verified.

### TECHNICAL FIELD

The present disclosure generally relates to verifying transactions in network communications and, particularly, verifying records that document real-time transactions.

### BACKGROUND

A server charged with monitoring and verifying transactions expends immense processing and network bandwidth resources. Hundreds of thousands of transactions can be made in a single day, each transaction carrying data that must be monitored and verified by the server. One way in which a transaction is verified is through cross checking transaction data generated during the transaction against a records documenting the completion of the transaction. Since providing records to the server is a manual process, the server receives the records upon one or more requests to a user controlling access to the record. Each of these requests requires both processing and network bandwidth resources: processing resources to generate the request and network bandwidth resources to transmit the request to the user. Because each transaction may demand repeated requests, the server is expending an immense amount of processing and network bandwidth resources to monitor and verify transactions.

### SUMMARY

Embodiments are related to transaction verification processes and architectures that reduce the processing and network bandwidth resource consumption by a computing server handling the transaction verification. In one embodiment, a computing server receives selection criteria from an organization client, where the selection criteria specifies transactions that need to be verified. The computing server processes real-time transactions on behalf of the organization client, where each of the real-time transactions were incurred between a third-party named entity and a transaction account associated with the organization client. The computing server identifies real-time transactions as unverified transactions using the selection criteria, where each of the unverified transactions includes transaction data fields that need to be verified (e.g., an amount of the transaction). The computing server receives, through a communication channel and from an end user associated with the organization client, a forward of a documentation record that is automatically generated by a particular third-party named entity acknowledging an occurrence of a particular real-time transaction. The computing server then parses the information in the documentation record. The computing server identifies an unverified transaction that matches the information parsed from the documentation record and matches the information parsed to data in the unverified transaction, identifying the fields that are verified due to the matches. The computing server may then cause a graphical user interface (GUI) that allows the organization client to manage the real-time transactions to display that the verified fields in the particular real-time transaction.

### BRIEF DESCRIPTION OF THE DRAWINGS

Figure (FIG. 1 is a block diagram illustrating an example system environment, in accordance with an embodiment.

FIG. 2 is a block diagram illustrating components of an example computing server, in accordance with an embodiment.

FIG. 3 is an interaction diagram depicting a computer-implemented process for verifying a record of a transaction, in accordance with an embodiment.

FIG. 4 depicts example record verification interactions using a device of an end user, in accordance with an embodiment.

FIG. 5 illustrates a record verification control portal, in accordance with an embodiment.

FIG. 6 illustrates an interface for viewing a verified record, in accordance with an embodiment.

FIG. 7 illustrates a verification setting portal, in accordance with an embodiment.

FIG. 8 is a conceptual diagram illustrating a machine learning model, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Overview

Figure (FIG. 1 is a block diagram that illustrates a spending system management environment 100, in accordance with an embodiment. The system environment 100 includes a computing server 110, a data store 120, an end user transaction device 130, a client device 140, and a transaction terminal 150. The entities and components in the system environment 100 communicate with each other through a network 160. In various embodiments, the system environment 100 includes fewer or additional components. In some embodiments, the system environment 100 also includes different components. While each of the components in the system environment 100 is described in a singular form, the system environment 100 may include one or more of each of the components. For example, in many situations, the computing server 110 can issue multiple end user transaction devices 130 for different end users. Different client devices 140 may also access the computing server 110 simultaneously.

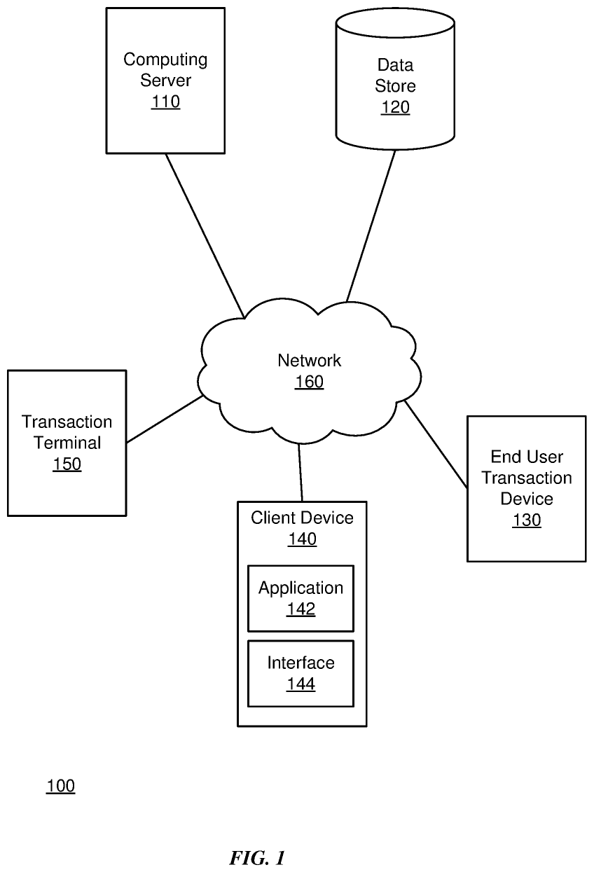

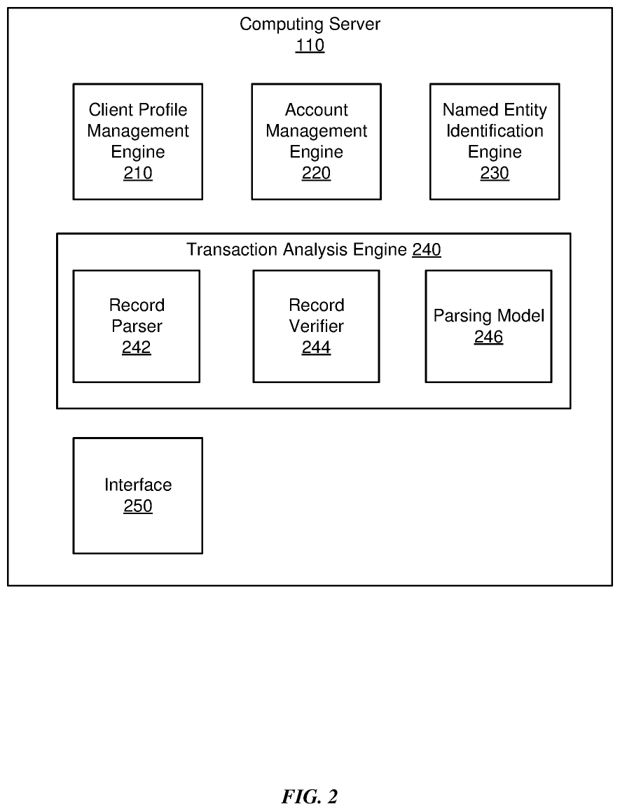

The computing server 110 includes one or more computers that perform various tasks related to managing accounting, payments, and transactions of various clients of the computing server 110. For example, the computing server 110 creates credit cards and accounts for an organization client and manages transactions of the cards of the organization client based on rules set by the client (e.g., pre-authorization and restrictions on certain transactions). Examples of organizations may include commercial businesses, educational institutions, private or government agencies, or any suitable group of one or more individuals that engage in transactions with a named entity (e.g., a merchant) using an account associated with a credit card. In some embodiments, a named entity may be an identifiable real-world entity that may be detectable in data of an organization. For example, a specific merchant may be a named entity and a merchant may refer to an organization that provides goods or services for purchase using the end user transaction device 130. An end user may be a member of an organization client such as an employee of the organization or an individual that uses the end user transaction device 130 to make purchase from a named entity. In one embodiment, the computing server 110 provides its clients with various payment and spending management services as a form of cloud-based software, such as software as a service (SaaS). Examples of components and functionalities of the computing server 110 are discussed in further detail below with reference to FIG. 2. The computing server 110 may provide a SaaS platform for various clients to manage their accounts and transaction rules related to the accounts.

The data store 120 includes one or more computing devices that include memory or other storage media for storing various files and data of the computing server 110. The data stored in the data store 120 includes accounting information, transaction data, credit card profiles, card rules and restrictions, merchant profiles, merchant identification rules, documentation records (“records”), record verification rules, and other related data associated with various clients of the computing server 110. In various embodiments, the data store 120 may take different forms. In one embodiment, the data store 120 is part of the computing server 110. For example, the data store 120 is part of the local storage (e.g., hard drive, memory card, data server room) of the computing server 110. In some embodiments, the data store 120 is a network-based storage server (e.g., a cloud server). The data store 120 may be a third-party storage system such as AMAZON AWS, DROPBOX, RACKSPACE CLOUD FILES, AZURE BLOB STORAGE, GOOGLE CLOUD STORAGE, etc. The data in the data store 120 may be structured in different database formats such as a relational database using the structured query language (SQL) or other data structures such as a non-relational format, a key-value store, a graph structure, a linked list, an object storage, a resource description framework (RDF), etc. In one embodiment, the data store 120 uses various data structures mentioned above.

An end user transaction device 130 is a device that enables the holder of the device 130 to perform a transaction with a party (e.g., a named entity), such as making a payment to a merchant for goods and services based on information and credentials stored at the end user transaction device 130. An end user transaction device 130 may also be referred to as an end user payment device. Examples of end user transaction devices 130 include payment cards such as credit cards, debit cards, and prepaid cards, other smart cards with chips such as radio frequency identification (RFID) chips, portable electronic devices such as smart phones that enable payment methods such as APPLE PAY or GOOGLE PAY, and wearable electronic devices. The computing server 110 issues end user transaction devices 130 such as credit cards for its organization clients and may impose spending control rules and restrictions on those cards. While credit cards are often used as examples in the discussion of this disclosure, various architectures and processes described herein may also be applied to other types of end user transaction devices 130. In some cases, an end user transaction device 130 may also be a virtual device such as a virtual credit card.

A client device 140 is a computing device that belongs to a client of the computing server 110. A client uses the client device 140 to communicate with the computing server 110 and performs various payment and spending management related tasks such as creating credit cards and associated payment accounts, setting transaction and record verification rules and restrictions on cards, setting pre-authorized or prohibited merchants or merchant categories (e.g., entertainment, travel, education, health, etc.), and managing transactions and records (e.g., verifying a documentation record). The user of the client device 140 may be a manager, an accounting administrator, or a general employee of an organization. While in this disclosure a client is often described as an organization, a client may also be a natural person or a robotic agent. A client may be referred to an organization or its representative such as its employee. A client device 140 includes one or more applications 142 and interfaces 144 that may display visual elements of the applications 142. The client device 140 may be any computing device. Examples of such client devices 130 include personal computers (PC), desktop computers, laptop computers, tablets (e.g., iPADs), smartphones, wearable electronic devices such as smartwatches, or any other suitable electronic devices.

The application 142 is a software application that operates at the client device 140. In one embodiment, an application 142 is published by the party that operates the computing server 110 to allow clients to communicate with the computing server 110. For example, the application 142 may be part of a SaaS platform of the computing server 110 that allows a client to create credit cards and accounts and perform various payment and spending management tasks (e.g., confirm documentation records have been verified). In various embodiments, an application 142 may be of different types. In one embodiment, an application 142 is a web application that runs on JavaScript and other backend algorithms. In the case of a web application, the application 142 cooperates with a web browser to render a front-end interface 144. In another embodiment, an application 142 is a mobile application. For example, the mobile application may run on Swift for iOS and other APPLE operating systems or on Java or another suitable language for ANDROID systems. In yet another embodiment, an application 142 may be a software program that operates on a desktop computer that runs on an operating system such as LINUX, MICROSOFT WINDOWS, MAC OS, or CHROME OS.

An interface 144 is a suitable interface for a client to interact with the computing server 110. The client may communicate to the application 142 and the computing server 110 through the interface 144. The interface 144 may take different forms. In one embodiment, the interface 144 may be a web browser such as CHROME, FIREFOX, SAFARI, INTERNET EXPLORER, EDGE, etc. and the application 142 may be a web application that is run by the web browser. In one embodiment, the interface 144 is part of the application 142. For example, the interface 144 may be the front-end component of a mobile application or a desktop application. In one embodiment, the interface 144 also is a graphical user interface (GUI) which includes graphical elements and user-friendly control elements. In one embodiment, the interface 144 does not include graphical elements but communicates with the data management server 120 via other suitable ways such as application program interfaces (APIs), which may include conventional APIs and other related mechanisms such as webhooks.

In some embodiments, the client device 140 and the end user transaction device 130 belong to the same domain. For example, a company client can request the computing server 110 to issue multiple company credit cards for the employees. A domain refers to an environment in which a system operates and/or an environment for a group of units and individuals to use common domain knowledge to organize activities, information and entities related to the domain in a specific way. An example of a domain is an organization, such as a business, an institute, or a subpart thereof and the data within it. A domain can be associated with a specific domain knowledge ontology, which could include representations, naming, definitions of categories, properties, logics, and relationships among various concepts, data, transactions, and entities that are related to the domain. The boundary of a domain may not completely overlap with the boundary of an organization. For example, a domain may be a subsidiary of a company. Various divisions or departments of the organization may have their own definitions, internal procedures, tasks, and entities. In other situations, multiple organizations may share the same domain.

A transaction terminal 150 is an interface that allows an end user transaction device 130 to make electronic fund transfers with a third party such as a third-party named entity. Electronic fund transfer can be credit card payments, automated teller machine (ATM) transfers, direct deposits, debits, online transfers, peer-to-peer transactions such as VENMO, instant-messaging fund transfers such as FACEBOOK PAY and WECHAT PAY, wire transfer, electronic bill payment, automated clearing house (ACH) transfer, cryptocurrency transfer, blockchain transfer, etc. Depending on the type of electronic fund transfers, a transaction terminal 150 may take different forms. For example, if an electronic fund transfer is a credit card payment, the transaction terminal 150 can be a physical device such as a point of sale (POS) terminal (e.g., a card terminal) or can be a website for online orders. An ATM, a bank website, a peer-to-peer mobile application, and an instant messaging application can also be examples of a transaction terminal 150. The third party is a transferor or transferee of the fund transfer. For example, in a card transaction, the third party may be a named entity (e.g., a merchant). In an electronic fund transfer such as a card payment for a merchant, the transaction terminal 150 may generate a transaction data payload that carries information related to the end user transaction device 130, the merchant, and the transaction. The transaction data payload is transmitted to other parties, such as credit card companies or banks, for approval or denial of the transaction.

In various embodiments, a named entity such as a merchant may automatically generate a documentation record to document an occurred transaction such as a real-time transaction. The documentation record, which may also simply be referred to as a record, may be generated by the transaction terminal 150 or a server of the named entity. A documentation record serves as a record of a transaction between a named entity and an end user. For example, after a purchase using a POS terminal, the terminal (which broadly may mean the terminal itself or the server of the terminal) may automatically generate a paper or email receipt for the customer. A documentation record can include the name of the named entity, a location at which the transaction occurred, a time at which the transaction occurred, an amount which was exchanged during the transaction (e.g., an amount of currency), an itemized list of goods or services purchased, a whole or portion of an identifier of the end user transaction device 130 (e.g., the last four digits of a credit card number), any suitable data describing the transaction, or a combination thereof. The transaction terminal 150 may provide the generated documentation record to the end user transaction device 130, a computing device of the end user (e.g., a laptop computer of the end user), the computing server 110, or a combination thereof. In some embodiments, the documentation record may be included within the transaction data payload. The documentation record may take various forms, including a paper receipt, a digital image of a paper receipt, an email, a short message service (SMS) text, a Quick Response (QR) code, a physical invoice, an electronic invoice, a statement, or any suitable form for providing data describing a transaction to the end user or the computing server 110.

Various servers in this disclosure may take different forms. In one embodiment, a server is a computer that executes code instructions to perform various processes described in this disclosure. In another embodiment, a server is a pool of computing devices that may be located at the same geographical location (e.g., a server room) or be distributed geographically (e.g., clouding computing, distributed computing, or in a virtual server network). In one embodiment, a server includes one or more virtualization instances such as a container, a virtual machine, a virtual private server, a virtual kernel, or another suitable virtualization instance.

The network 160 provides connections to the components of the system environment 100 through one or more sub-networks, which may include any combination of local area and/or wide area networks, using both wired and/or wireless communication systems. In one embodiment, a network 160 uses standard communications technologies and/or protocols. For example, a network 160 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 160 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 160 may be represented using any suitable format, such as hypertext markup language (HTML), extensible markup language (XML), JavaScript object notation (JSON), structured query language (SQL). In some embodiments, some of the communication links of a network 160 may be encrypted using any suitable technique or techniques such as secure sockets layer (SSL), transport layer security (TLS), virtual private networks (VPNs), Internet Protocol security (IPsec), etc. The network 160 also includes links and packet switching networks such as the Internet. In some embodiments, a data store belongs to part of the internal computing system of a server (e.g., the data store 120 may be part of the computing server 110). In such cases, the network 160 may be a local network that enables the server to communicate with the rest of the components.

### Example Server Components

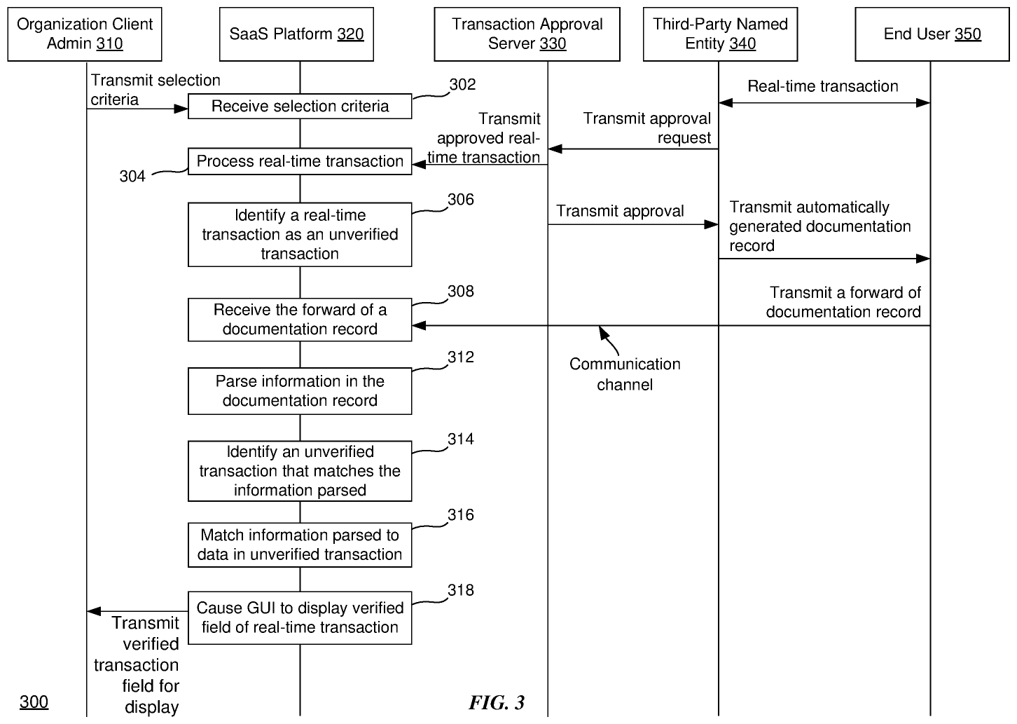

FIG. 2 is a block diagram illustrating components of a computing server 110, in accordance with an embodiment. The computing server 110 includes a client profile management engine 210, an account management engine 220, a named entity identification engine 230, a transaction analysis engine 240, and an interface 250. In various embodiments, the computing server 110 may include fewer or additional components. For example, in some embodiments, the computing server 110 may also include transaction approval server 330 that will be discussed in further detail in FIG. 3. The computing server 110 also may include different components. The functions of various components may be distributed in a different manner than described below. Moreover, while each of the components in FIG. 2 may be described in a singular form, the components may present in plurality. The components may take the form of a combination of software and hardware, such as software (e.g., program code comprised of instructions) that is stored on memory and executable by a processing system (e.g., one or more processors).

The client profile management engine 210 stores and manages end user data and transaction data of clients of the computing server 110. The computing server 110 can serve various clients associated with end users such as employees, vendors, and customers. For example, the client profile management engine 210 may store the employee hierarchy of a client to determine the administrative privilege of an employee in creating a credit card account and in setting transaction and record verification rules. An administrator of the client may specify that certain employees from the financial department and managers have the administrative privilege to create cards for other employees. The client profile management engine 210 assigns metadata tags to transaction data of an organization to categorize the transactions in various ways, such as by transaction types, by merchants, by date, by amount, by card, by employee groups, etc. The client profile management engine 210 can monitor the spending of a client by category and also by the total spending. The spending amounts may affect the results of transaction and record verification rules that are specified by a client's system administrator. For example, a client may limit the total monthly spending of an employee group. The computing server 110 may deny further card payments after the total spending exceeds the monthly budget.

The transaction data stored by the client profile management engine 210 can include a record of a transaction, where the record includes data such as an amount of the transaction, the date of the transaction, a named entity that accepted a request by the end user to initiate the transaction (e.g., the merchant that accepted an end user's request to purchase the merchant's service), or combination thereof. The client profile management engine 210 may store the data in a data structure and/or store the record as provided by a device of the end user or the transaction terminal 150. For example, the client profile management engine 210 may store images of receipts as taken by a camera of a computing device (e.g., smart phone) of an end user. In another example, the client profile management engine 210 may store emailed receipts as provided by a transaction terminal 150.

The client profile management engine 210 may also store and manage associations between two clients. The two clients may share one or more end users. For example, an end user is an employee at the two clients. The two clients may have respective profiles with the client profile management engine 210, the two profiles indicating that the end user is an employee with user identifiers (e.g., a mobile phone number and an email address) at a first of the two clients and another user identifier (e.g., a different email address) at the second of the two clients. The client profile management engine 210 may create a mapping of the end user to the two client profiles upon a client administrator specifying that the mapping be created (e.g., using the interface 144 at the client device 140). For example, the client profile management engine 210 may receive two user-specified clients and connect client profiles. Alternatively or additionally, the client profile management 210 may receive two user-specified accounts and connect the accounts. The mapping may be identified using a user identifier associated with the two mapped client profiles. The mapping may be used by the transaction analysis engine 240 to verify a documentation record against a transaction associated with either of the mapped clients or mapped accounts.

The account management engine 220 creates and manages accounts including payment accounts such as credit cards that are issued by the computing server 110. An account is associated with an end user such as an employee and corresponds to a card or an end user transaction device. A client may use the computing server 110 to issue domain-specific payment accounts such as company cards. The client enters account information such as the cardholder's name, role and job title of the cardholder in the client's organization, limits of the card, and transaction rules associated with the card. The client may use the client device 140 and the interface 144 to supply this information to the computing server 110. In response to receiving the account information (e.g., from the client device 140), the account management engine 220 creates the card serial number, credentials, a unique card identifier, and other information needed for the generation of a payment account and corresponding card. The account management engine 220 associates the information with the cardholder's identifier. The computing server 110 communicates with a credit card company (e.g., VISA, MASTERCARD) to associate the card account created with the identifier of the computing server 110 so that transactions related to the card will be stored at client profile management engine 210 with a mapping to identifiers for the account and the client's organization for querying transactions of the client organization. The account management engine 220 may also order the production of the physical card that is issued under the computing server 110. The cards and payment accounts created are associated with the transaction and documentation record verification rules that are specified by the client's administrator.

In some embodiments, the account management engine 220 creates rules for verifying records. A client may specify rules under which records are to be verified by the computing server 110. The client may use the interface 144 of the client device 140 to specify the rules. The rules may include a location, time, named entity, end user, account, amount (e.g., purchase amount), or any suitable parameter related to a transaction. In one example of a rule, the client specifies that a documentation record is not required to be verified for transaction amounts below 75 dollars for merchants in a travel category. In another example of a rule, the client specifies that a documentation record is required to be verified for transactions made outside of the United States. The client may specify priority for rules such that a certain rule may override another rule. For example, the account management engine 220 may determine that, under the previous two examples of rules, the client has specified that rules for requiring record verification overrides rules for not requiring verification, and cause the transaction analysis engine 240 to verify a documentation record for, for example, a transaction made for a train ticket in Europe using an end user transaction device issued for an end user of the client.

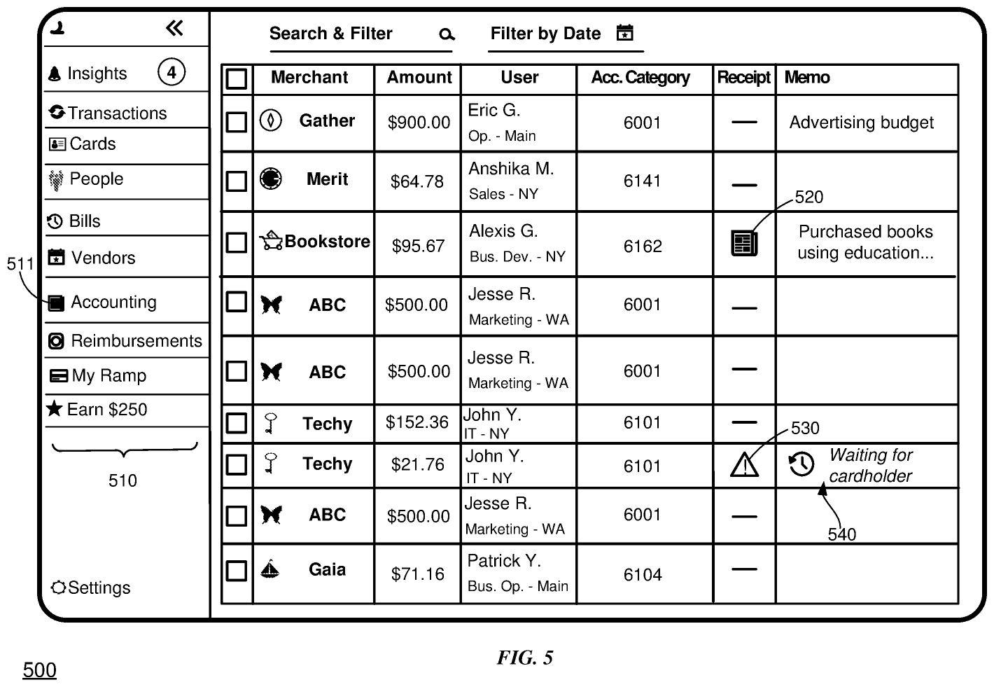

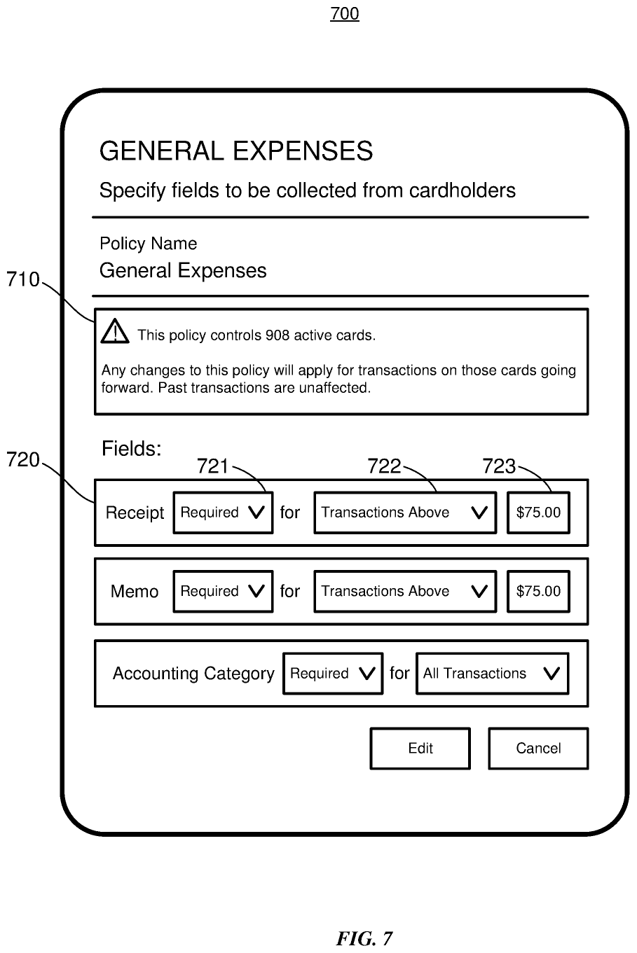

Upon determining that verification is or is not needed using the rules created by the account management engine 220, the transaction analysis engine 240 may annotate a record of the transaction with an indicator for the corresponding verification requirement (e.g., verification needed or not needed). This indicator may be used when generating a user interface for the client when managing verification statuses of past transactions (e.g., example interface of FIG. 5). Additionally, the indicator may be used to generate notifications to end users to notify the end users of the rules under which a documentation record is not necessary, which may prevent subsequent upload of records and save communication bandwidth and server storage resources. A client may establish such rules through an interface generated by the interface 250 (e.g., example interface of FIG. 7).

The named entity identification engine 230 identifies specific named entities (e.g., merchants) associated with various transactions. The computing server 110 may impose an entity-specific restriction on a card. For example, an administrator of a client may specify that a specific card can only be used with a specific named entity. The computing server 110 parses transaction data from different clients to identify patterns in the transaction data specific to certain named entities to determine whether a transaction belongs to a particular named entity. For example, in a card purchase, the transaction data includes merchant identifiers (MID), merchant category code (MCC), and the merchant name. However, those items are often insufficient to identify the actual merchant of a transaction. The MID is often an identifier that does not uniquely correspond to a merchant. In some cases, the MID is used by the POS payment terminal company such that multiple real-world merchants share the same MID. In other cases, a merchant (e.g., a retail chain) is associated with many MIDs with each branch or even each registry inside a branch having its own MID. The merchant name also suffers the same defeats as the MID. The merchant name may also include different abbreviations of the actual merchant name and sometimes misspelling. The string of the merchant name may include random numbers and random strings that are not related to the actual real-world name of the merchant. The named entity identification engine 230 applies various algorithms and machine learning models to determine the actual merchant from the transaction data. For example, the named entity identification engine 230 may search for patterns in transaction data associated with a particular merchant to determine whether a transaction belongs to the merchant. For example, a merchant may routinely insert a code in the merchant name or a store number in the merchant name. The named entity identification engine 230 identifies those patterns to parse the actual merchant name.

A named entity identification process may be used to determine the identities of named entities included in processed real-time transaction. In one embodiment, the computing server 110 determines a named entity identification rule by analyzing patterns in the volume of data associated with the plurality of clients. For example, the volume of data may include past transaction data payloads of different clients. The computing server 110 may analyze the past transaction data payloads to determine a common pattern associated with payloads of a particular named entity. The named entity identification rule may specify, for example, the location of a string, the prefix or suffix to removed, and other characteristics of the data payload. The computing server 110, upon the receipt of a transaction data payload, identifies a noisy data field in the transaction data (e.g., a noisy string of text). A noisy data field is a field that includes information more than the named entity. For example, a noisy data field may include a representation of a named entity, such as the name, an abbreviation, a nickname, a subsidiary name, or an affiliation of the named entity. The noisy data field may further include one or more irrelevant strings that may be legible but irrelevant or may even appear to be gibberish. The computing server 110 parses the representation of the named entity based on the named entity identification rule. A transaction approval process can be based on the identity of the named entity. This general framework may be used by one or more computing servers to identify named entities in transaction data payloads.

U.S. patent application Ser. No. 17/351,120, entitled “Real-time Named Entity Based Transaction Approval” and filed on Jun. 17, 2021, is incorporated in its entirety herein for all purposes.

The transaction analysis engine 240 analyzes documentation records to verify a documentation record matches a transaction made using an end user transaction device. This verification enables the computing server 110 to notify a client of potential anomalous purchases (e.g., made by a thief) that have not been cleared or labeled as trustworthy (i.e., the end user did indeed participate in the transaction) using a verified documentation record. The transaction analysis engine 240 includes a record parser 242, a record verifier 244, and a parsing model 246. The transaction analysis engine 240 may receive a documentation record (e.g., from a transaction terminal or from an end user), parse the record for data relating to the transaction, and cross-check the data against past transaction data associated with transaction devices issued for an organization client by the computing server 110.

The record parser 242 extracts data about a transaction from a documentation record. The record parser 242 may receive documentation records unprompted from an end user (e.g., from an end user transaction device). That is, the record parser 242 receives documentation records without necessarily prompting an end user to provide the documentation records or without having immediate context for associating the received documentation record to a transaction incurred by a transaction account. The record parser 242 may perform different methods of data extraction depending on the medium in which the documentation record is provided. For example, a record may be an image of a paper receipt, and the record parser 242 may apply optical character recognition (OCR) to the image to determine various strings of text depicted in the image. The strings of text may include transaction information such as the amount of the transaction, date of transaction, location of the transaction, the named entity associated with the transaction, or a combination thereof. The record parser 242 may use regular expressions or any suitable string search pattern to determine that a particular string corresponds to a particular transaction information. For example, the record parser 242 may use a search pattern corresponding to the symbol “+” followed by a sequence of numbers to determine a phone number of a merchant and the country in which the merchant is located based on the phone number's country code. The record parser 242 may apply parsing rules with determined transaction information to determine additional transaction information. For example, the record parser 242 may determine the country using a country code of a phone number as determined in the previous example and apply a search pattern for an amount of a transaction for a currency format of that country (e.g., using a search pattern with a decimal point for the US dollar and a decimal comma for the Norwegian kroner).

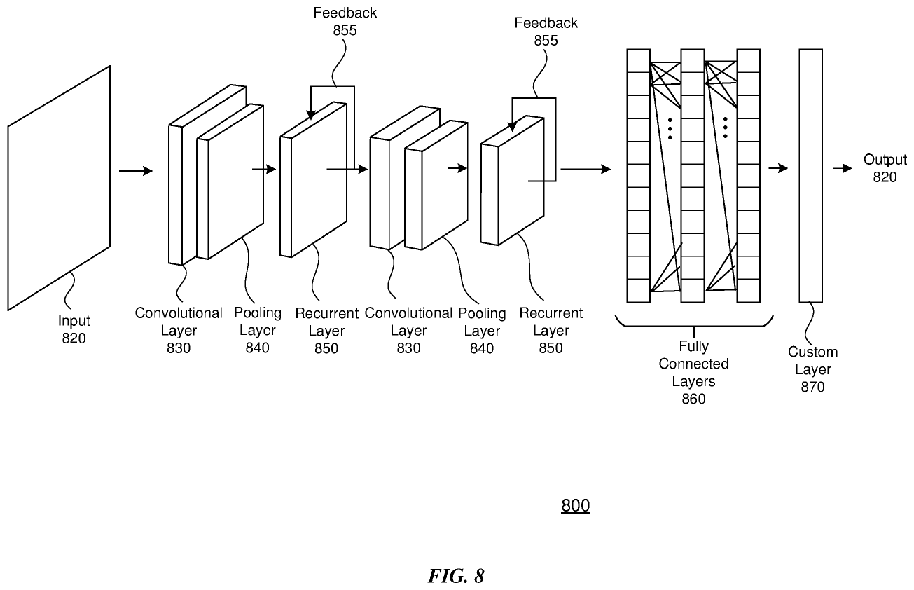

The record parser 242 may apply the parsing model 246 to a documentation record to parse information in the documentation record. The parsing model 246 receives, as input, a documentation record or representation thereof (e.g., a feature vector where values of the vector are related to the documentation record) and determines, as output, information in the documentation record (e.g., an amount of a transaction recorded by the documentation record, a date of the transaction, or a name of a third-party named entity involved in the transaction). In one example, the parsing model 246 receives images of receipts of transactions as input and is trained on images of receipts of past transactions, where the training images are labeled with data of the past transactions (e.g., transaction amount, transaction time, named entity name, etc.). The parsing model 246 is thus configured to receive an image of a receipt and determine transaction data depicted in the image. The parsing model 246 may include one or more machine learning models that are trained to recognize text and natural language. One or more machine learning models may also be trained to identify relevant fields in a documentation record, such as where the date, merchant name and transaction amount are located. One or more machine learning models may also be trained to recognize named entities. Examples of training of machine learning models are further discussed in FIG. 8.

The record verifier 244 verifies the transaction data parsed by the record parser 242 against a past transaction record. By verifying the documentation record matches a past transaction, the record verifier 244 can confirm that a transaction device is not being misused by a malicious actor (e.g., an identity thief who is not aware of the procedure to provide documentation records to the computing server 110) or enable the client to supervise use of the transaction device (e.g., using itemized documentation records). The record verifier 244 can determine an end user, account, or client associated with the record and compare the transaction data of the record to unverified transactions in past transaction data (e.g., stored in the client profile management engine 210). The record verifier 244 may determine whether the transaction of the record is an unverified transaction by determining whether a threshold number of verification criteria are satisfied. The verification criteria can include a matching transaction amount, matching transaction date, matching named entity (e.g., merchant), or any suitable data related to a transaction that is recorded or reported in the execution of a transaction (e.g., by the transaction terminal 150). A client can specify the verification criteria to the computing server 110 (e.g., via the interface 144). The threshold number may be at least half of the total number of verification criteria. For example, a documentation record must meet at least two of three verification criteria of merchant name, transaction date, and transaction location.

The record verifier 244 may determine an end user, account, or client associated with a documentation record. In some embodiments, the record verifier 244 identifies a client profile associated with the transaction corresponding to the received documentation record. The record verifier 244 may receive the documentation record from a sender identified by a user identifier, which may be an electronic address (e.g., an email address), a phone number, a physical address, or any suitable sender identifier. The record verifier 244 may use the user identifier to identify the client profile. In one example of identifying the client profile, the record is an image of a receipt of a transaction provided to the computing server 110 from a client device (e.g., mobile phone) having a particular phone number. The record verifier 244 may use the phone number as a user identifier and query the client profile management engine 210 for a client profile having information about an end user having the phone number and transactions made by end users of the client. Alternatively or additionally, the record verifier 244 may use the phone number to query the account management engine 220 to determine which account is associated with the transaction depicted in the image. Upon identifying the phone number is associated with a particular client or account, the record verifier 244 identifies past transactions made by transaction devices of the particular client or account.

In another example of using a user identifier to identify a client or account associated with a received record, the record may be an email of a receipt. The email may have one or more headers indicating the sender and recipient of an email message. In a chain of emails, there may be two or more headers indicating an original sender and intermediary senders. The original sender may be an end user that requested the transaction while an email address from which the record was sent to the computing server 110 was not involved in the transaction (e.g., an email handle of the client to which all receipts from employees are forwarded for processing such as ‘receiptprocessing@samplecorporation.com’). The record verifier 244 may parse through the email headers to determine a chain of senders and recipients to determine the original end user's email handle, which may be used to identify the end user's account and past transactions of that account.

In some embodiments, the record verifier 244 determines that there are no message headings in the email. When the message heading is absent, the record verifier 244 may find an account having past transactions that are to be cross checked with the transaction of the received documentation record by using past transactions of multiple accounts with a client, rather than a particular end user account. For example, the email may be received by a ‘receiptprocessing@samplecorporation.com’ email handle without any message headings, where this particular email handle is not associated with a particular individual. The record verifier 244 may determine that the email handle belongs to a particular client, ‘Sample Corporation,’ and identify all past, unverified transactions of Sample Corporation. In some embodiments, the record verifier 244 may limit the identification to a particular duration of time, saving processing resources by searching through less transaction records. For example, the record verifier 244 identifies past, unverified transactions made within the last 90 days rather than past, unverified transactions made since the client opened accounts with the computing server 110.

The interface 250 includes interfaces that are used to communicate with different parties and servers. The interface 250 may take the form of a SaaS platform that provides clients with access of various functionalities provided by the computing server 110. The interface 250 provides a portal in the form of a graphical user interface (GUI) for clients to create payment accounts, manage transactions, specify rules of each card, and verify records of transactions incurred using the cards. Examples of the GUI elements of the interface 250 are shown in FIGS. 5-7. The interface 250 is in communication with the application 142 and provides data to render the application 142.

In one embodiment, the interface 250 also includes an API for clients of the computing server 110 to communicate with the computing server 110 through machines. The API allows the clients to retrieve the computing server 110 stored in the data store 120, send query requests, and make settings through a programming language. Various settings, creation of cards, rules on the cards, rules of verifying records, and other functionalities of the various engines 210, 220, 230, and 240 may be changed by the clients through sending commands to the API.

### Record Verification Process

FIG. 3 is an interaction diagram a depicting computer-implemented process 300 for verifying a record of a transaction, in accordance with an embodiment. The process 300 is performed among an organization client administrator 310, a SaaS platform 320, a transaction approval server 330, a third-party named entity 340, and an end user 350. The administrator 310 and the end user 350 may use computing devices to perform the particular interactions shown the process 300 (e.g., incurring a real-time transaction with the third-party named entity 340). For the particular embodiment discussed in FIG. 3, the SaaS platform 320 and the transaction approval server 330 are located separately (e.g., independently operating servers). In some embodiments, both SaaS platform 320 and the transaction approval server 330 may be part of the computing server 110 or controlled by the computing server 110. In the embodiment discussed in FIG. 3, the SaaS platform 320 is controlled by the computing server 110 and shares functionality with the computing server 110 described with respect to FIG. 2. In some embodiments, the computing server 110 may perform some or all of the operations described with respect to FIG. 3 (e.g., the transaction approval performed by the transaction approval server 330).

The SaaS platform 320 receives 302 selection criteria transmitted by an organization client administrator 310. The selection criteria may specify transactions that need to be verified. The criteria may relate to parameters of a transaction (e.g., amount, date, location, goods or service purchased, etc.), parameters of a transaction account (e.g., the end user, an employee title of the end user, a credit limit of the account, etc.), parameters of the third-party named entity (e.g., the name of a merchant, a location of the merchant, a merchant category, etc.), or any suitable parameter describing the transaction. In one example of selection criteria, the administrator 310 specifies that transactions made for an amount over one hundred dollars during the months of June through August in the “travel” merchant category are required to be verified. An example user interface for specifying selection criteria is shown in FIG. 7.

The SaaS platform 320 processes 304 a real-time transaction. A real-time transaction may be a credit card purchase or another event where the transaction approval server 330 is asked to approve in real time a transaction that involves a transaction account managed by the computing server 110. The SaaS platform 320 may process 304 transactions on behalf of the organization client of the administrator 310. The transactions can occur between respective third-party named entities and respective transaction accounts associated with the organization client. The process 300 depicts a real-time transaction incurred between the third-party named entity 340 and the end user 350. For example, the third-party named entity 340 may be an airline ticketing service and the end user 350 may use a computing device (e.g., a laptop) and an end user transaction device (e.g., a credit card) to purchase plane tickets online from a website of the third-party named entity 340. The third-party named entity 340 may transmit an approval request to the transaction approval server 330 to fulfill the transaction (e.g., for fraud prevention). Upon approving the transaction, the transaction approval server 330 may transmit the approval of the real-time transaction to both the SaaS platform 320 and the third-party named entity 340. The SaaS platform 320 may receive information regarding the approved transaction such as the transaction account (e.g., credit card number) involved in the transaction, the named-entity involved in the transaction, the amount, and the date of the transaction. The SaaS platform 320 may process 304 the received, approved real-time transactions by storing the transaction information in a database (e.g., in the account management engine 220). The SaaS platform 320 may maintain a data structure of the transaction information, where each entry in the data structure corresponds to a real-time transaction. In a given period, the computing server 110 may manage different organization clients and each client may have a large number of transaction accounts (e.g., corporate credit card accounts). As such, the computing server 110 may process a large number of real-time transactions on behalf of various organization clients.

The SaaS platform 320 identifies 306 a real-time transaction as an unverified transaction. The SaaS platform 320 may use the selection criteria specified by the organization client administrator 310 to identify the unverified transaction. The unverified transaction includes one or more fields that need to be verified. For example, the selection criteria specifies that transactions with amounts over one hundred dollars during the months of June through August in the “travel” merchant category are required to be verified. Using these criteria and the transaction information processed 304 earlier, the SaaS platform 320 identifies 306 the real-time transaction for an airplane ticket purchased for five hundred dollars in July as an unverified transaction. The unverified transaction includes one or more fields that need to be verified. The fields to be verified can also be specified by the organization client administrator 310 to the SaaS platform 320. The fields can include an amount of the transaction, a date of the transaction, a name of the named-entity involved in the transaction (e.g., a merchant name), or any other suitable parameter of the transaction that is provided with a documentation record.

The SaaS platform 320 receives 308 a forward of a documentation record. A documentation record may be a receipt of a transaction in any suitable medium for parsing by a computing device (e.g., an image of a paper receipt, a copy of an email, a text message, etc.). After receiving the approved for a real-time transaction request, the third-party named entity 340 may automatically generate a documentation record (e.g., a receipt) for the approved transaction and transmit the receipt to the end user 350 (e.g., emailing the receipt or providing a paper receipt to the end user 350). The documentation record may be automatically generated by the third-party named entity 340 to acknowledge the occurrence of a particular real-time transaction (e.g., acknowledging that the end user 350 has purchased an airplane ticket). The end user 350 may then provide a forward of the generated documentation record.

In some embodiments, forwards may be sent by various end users to one or more designated recipient destinations that may be generic and non-specific to a particular user. The destination may depend on the type of channels used in transmitting the forward. The destination may be managed by the organization client or may have a designation associated with the organization (e.g., an email address using the organization's email domain) The destination may be managed by the organization or directly by the computing server 110. For example, if the channel is email, various employees of a business may forward purchase receipts to a designated email address of the business that is used to collect receipts (e.g., receipts@company.com). The destination may be non-specific to any user and various employees may use the same addresses. If the channel is SMS, the destination may be a phone number owned by the business that is used to collect receipt. The employees can take an image of a physical receipt and forward the image to the phone number via SMS. Upon receiving the forwards, the business may transmit the information to the computing server 110 or, in some embodiments, the computing server 110 may directly manage the destinations.

In various embodiment, a forward may be a direct capture or re-transmission of a documentation record. In some embodiments, an end user 350 who performs the forward may not need to manually perform additional labelling or fill out information in the forward. For example, in one embodiment, a forward may be an image (a direct capture) of a paper receipt without the end user 350 manually label the receipt or entering the information in the receipt. In another embodiment, a merchant may generate an electronic receipt that is sent to the end user's email. A forward in this example may be a direct forward of the email by the end user 350 to a designated email address of the organization (e.g., receipt@company.com) or of the computing server.

In some embodiments, a forward may be prompted or unprompted. A prompted forward is a response of the end user 350 to a message asking for the documentation record, such as a reminder from computing server 110 that the end user 350 needs to upload a receipt image for a particular transaction. A forward may also be unprompted. For example, the end user 350 texts an image of a paper receipt to the SaaS platform 320 that is not necessarily in response to a text generated by the SaaS platform 320 asking the user to provide the documentation record (e.g., the SaaS platform 320 has not sent the end user a text reading “Please provide a receipt for your transaction made on Jul. 14, 2021 for 500 with FlyFast Airlines”). This unprompted text by the end user 350 forwards the paper receipt of their purchase. In this example, the end user 350 has provided the forward through a communication channel of a short message service (SMS) text.

In another example of a forward, the end user 350 forwards an email of a emailed receipt to the SaaS platform 320 without being prompted by the SaaS platform 320 to forward the email (e.g., the SaaS platform 320 did not send an email to the end user 350 asking for the emailed receipt). In this example, the forward is the forwarding of the emailed receipt through a communication channel of an email platform (e.g., a commercially available email service). In some embodiments, the end user 350 is not required to provide additional information in the forward, such as typing any further message or including any further information. The computing server 110, upon receipt of the forward, will automatically search for an unverified transaction to match the documentation record.

In yet another example of a forward, the end user 350 logs onto a website generated by the SaaS platform 320 using an account with the computing server 110. The end user 350 may upload an image of a receipt through the website without the website prompting the user to upload the image (e.g., without a webpage reading “Please provide a receipt for your transaction made on Jul. 14, 2021 for 500 with FlyFast Airlines in the input fields below”). In this example, the forward is the uploading of the receipt image through a communication channel of a website generated by the SaaS platform 320. In some embodiments, the end user 350 does not need to enter any information in the upload unless the SaaS platform 320 identifies that there is still information missing.

The SaaS platform 320 parses 312 the information in the documentation record. In some embodiments, the SaaS platform 320 may apply a machine learning model to parse the information in the documentation record. The documentation record may be an image and the machine learning model (e.g., the parsing model 246) may be a machine learning model trained to identify transaction data within images of receipts. For example, the SaaS platform 320 trained the machine learning model using images of physical receipts of past transactions, where the images were labeled with the transaction data that was depicted in the images (e.g., amounts of the transactions). In one example, the machine learning model parses an amount, date, and name of a merchant involved in a transaction from a picture of a receipt for the transaction. The SaaS platform 320 may additionally or alternatively train a machine learning model to receive digital files representing the documentation records (e.g., a MSG or PDF file of an emailed receipt) and output the information in the documentation record. In some embodiments, the SaaS platform 320 parses 312 the information in the documentation record using OCR.

The SaaS platform 320 identifies 314 an unverified transaction that matches the information parsed from the documentation record. The SaaS platform 320 matches 316 the information parsed from the documentation record to data in the unverified transaction to identify one or more fields that are verified. For example, the SaaS platform 320 matches 316 the transaction amount processed 304 in a previously received real-time transaction to a transaction amount identified in a documentation record that was parsed by a machine learning model. The SaaS platform 320 may identify 314 an unverified transaction by using a user identifier (e.g., email address) associated with a transaction account, identifying names of third-party named entities of transactions incurred using the transaction account, identify a date, time, and/or amount of one or more of the transactions incurred, and determine that all or some of the identified transactions satisfy selection criteria. These transactions that satisfy the selection criteria can be unverified transactions.

In some embodiments, the SaaS platform 320 identifies 314 the unverified transaction using an identifier of the end user 350 (e.g., a phone number, email address, username of an account with the SaaS platform). For example, the SaaS platform 320 receives an image of a receipt texted from a smartphone of the end user 350, matches the phone number of the smartphone to a transaction account stored in the client profile management engine 210, and identifies 314 an unverified transaction made by the matched transaction account, where the unverified transaction has the information parsed from the documentation record (e.g., the same amount, date, merchant name).

In some embodiments, the SaaS platform 320 identifies 314 the unverified transaction using one or more message headings in email receipts. The SaaS platform 320 identifies a message heading in an emailed receipt (e.g., a heading with the subject of the email, an address that the email is sent from, and an address that the email is sent to). The SaaS platform 320 determines, using the message heading, that the emailed receipt was transmitted from one user to the end user 350. For example, the SaaS platform 320 can parse the strings (e.g., using regular expressions) within message headings to determine a chain of senders and recipients. In this parsing, the SaaS platform 320 can determine the originating sender of the emailed receipt, and identify a transaction account associated with an email handle of the originating sender. The SaaS platform 320 identifies transactions incurred between third-party named entities and the transaction account associated with the originating sender, where the identified transactions include the unverified transaction.

Alternatively, the SaaS platform 320 may identify an absence of a message heading in an email receipt. For example, the SaaS platform 320 may use a regular expression to identify the structure of strings that compose a message heading, and fail to identify any structure of strings that matches a search pattern. The SaaS platform 320 may determine, using an email address of the end user who provided the documentation record (e.g., the end user 350), an organization client to which the end user is affiliated (e.g., the end user 350 is an employee of the organization client of the administrator 310). The SaaS platform 320 may make this determination by matching a domain name in the email addresses of the administrator 310 and the end user 350. The SaaS platform 320 may determine a set of transactions incurred between third-party named entities and transaction accounts issued for end users affiliated with the organization client. In some embodiments, the SaaS platform 320 may impose filters to limit the number of transactions identified. For example, the SaaS platform 320 determines transactions incurred between third-party named entities and transaction accounts during the past ninety days. The SaaS platform 320 may identify the unverified transaction corresponding to the email receipt among the set of transactions.

In some embodiments, the SaaS platform 320 identifies 314 the unverified transaction using linked transaction accounts with the SaaS platform 320. The SaaS platform 320 may maintain mappings between transaction accounts, where each of the transaction accounts can be assigned to one or more user account profiles with the SaaS platform 320 (e.g., accounts used to log into a webpage generated by the SaaS platform 320). The SaaS platform 320 may enable the administrator 310 to specify two transaction accounts that are to be mapped to one another. For example, the SaaS platform 320 generates a GUI with one or more input fields allowing the administrator 310 to enter the account numbers for the two transaction accounts that are to be mapped. The SaaS platform 320 may then store this mapping in the client profile management engine 210 or the account management engine 220. The end user 350 may log into the website of the SaaS platform 320 using a user account associated with one of their transaction accounts, but upload a documentation record for a transaction incurred using a different transaction account. The SaaS platform 320 may identify the mapping between the two transaction accounts (e.g., using the account number, user email, or other identification used to map the two transaction accounts as specified by an administrator) and identify the unverified transaction associated with the documentation record from transactions incurred with the different transaction account. The two transaction accounts may be associated with two different organization clients (e.g., the end user is employed by two different companies that both use the services of the SaaS platform). The SaaS platform can thus access, using the mapping, transaction history of another organization client to find the unverified transaction.

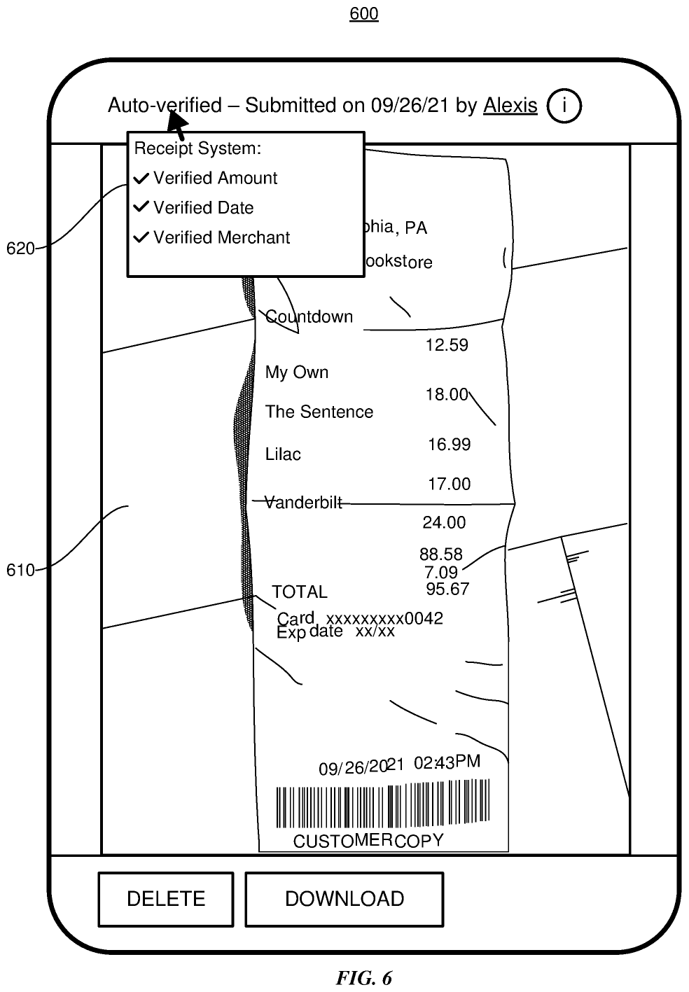

The SaaS platform 320 causes 318 a graphical user interface that allows the organization client to manage real-time transaction to display that fields of the real-time transaction have been verified. The SaaS platform 320 may display indicators showing that the matched 316 information was verified. An example of an interface showing the verified information is shown in FIG. 6. In some embodiments, the SaaS platform 320 causes a user interface to display input fields to receive manual verification from the administrator 310 that the fields that needed to be verified (e.g., transaction amount, date, merchant name) are present in the documentation record.

### Record Verification Interfaces

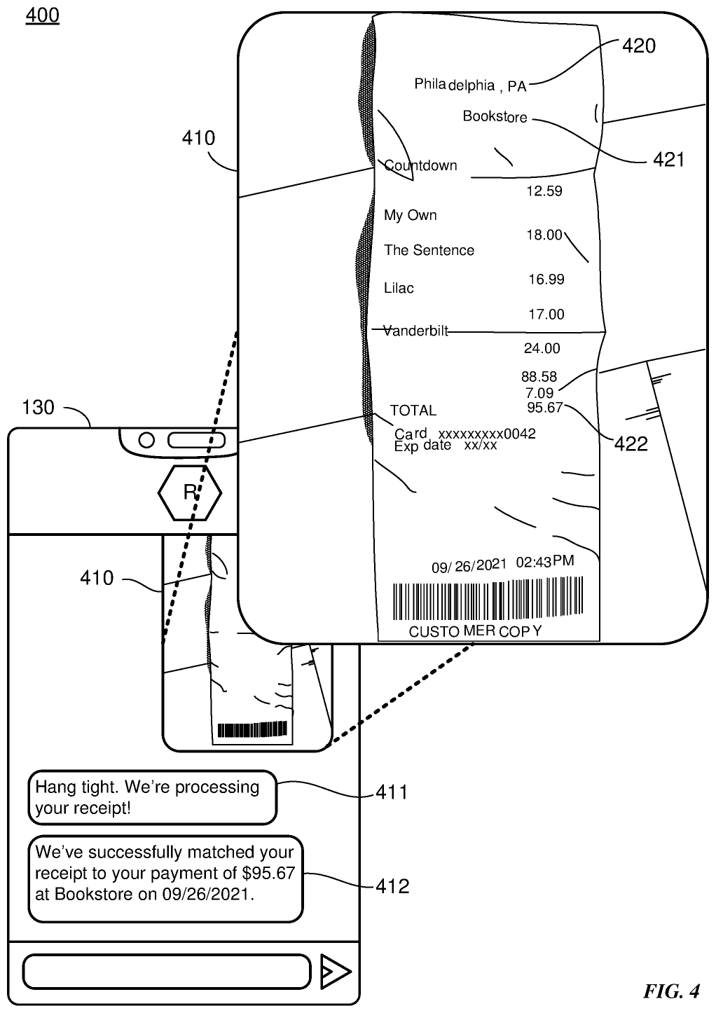

FIGS. 4-7 depict various interfaces for interacting with the computing server 110 to verify documentation records. An end user providing a documentation record to the computing server 110 (e.g., unprompted by the server) may provide the record through a communication platform such as an email platform, instant messaging platform, or short message service (SMS) platform. The communication platform interfaces with the computing server 110 (e.g., using an API) to provide the documentation record to the computing server 110 from a computing device of the end user. An example of this communication is depicted in FIG. 4. A client may view transactions and records and manage the verification of documentation records using various interfaces generated by the computing server 110. These interfaces may be generated on a client device (e.g., the interface 144 of the client device 140). Examples of interfaces for clients are depicted in FIGS. 5-7.

FIG. 4 depicts example record verification interactions using a device of an end user, in accordance with an embodiment. An end user who has completed a transaction with a named entity may take an image 410 of the receipt of the transaction. The image 410 is provided over SMS to the computing server 110 using an end user transaction device 130, a smartphone storing a digital representation of a credit card. The image 410 depicts a paper receipt of a purchase at a bookstore. In particular, the image 410 depicts transaction data such as a transaction location 420, a named entity 421, and a transaction amount 422. The end user sends the image 410 to a phone number associated with the computing server 110. The computing server 110 receives the image 410 and uses the transaction analysis engine 240 to verify the record. Upon receiving the image 410, the computing server 110 may provide a notification 411 confirming that the image 410 was received. The record parser 242 applies OCR to the image 410 to determine the transaction location 420, the named entity 421, and the transaction amount 422. The record verifier 244 uses the phone number of the device 130 to identify a credit card account profile used with device 130 was issued or to identify a client profile for which the credit card account used with device 130 is associated. The record verifier 244 uses the identified account or client profile to compare the parsed transaction data against past transaction data of the identified account or client profile. The record verifier 244 determines there is a past transaction that has data matching the parsed transaction data and in response, provides a notification 412 to the device 130 to inform the user that the documentation record was successfully verified.

FIG. 5 illustrates a record verification control portal 500, in accordance with an embodiment. The portal 500 is a GUI that may be provided by the interface 250 of the computing system 110. The portal 500 may be used by an organization client administrator to manage transaction accounts (e.g., credit cards) issued to end users. The portal 500 includes a navigation menu 510 and a navigation option 511 for “Accounting.” Upon selecting the option 511, the portal 500 may display a data structure (e.g., a table) listing transactions made with transaction accounts issued to the end users. As shown in the portal 500, the table is organized by fields such as merchant name, transaction amount, end user's name, accounting category, a flag indicating whether a documentation record has been updated, and a memo describing the transaction (e.g., the purpose of the transaction). A flag 520 indicates that a record was provided (e.g., via a forward of an image of a paper receipt) and a flag 530 indicates that a record is needed (e.g., as specified by selection criteria chosen by an administrator) but has not been provided by the end user. A computer server-generated memo 540 may provide further information to the administrator that the documentation record is needed. The entry in the table for a purchase at merchant “Bookstore” for a transaction amount of $95.67 corresponds to the example transaction depicted in FIGS. 4 and 6. An administrator may select the flag 520 and in response, the computing server 110 may provide an interface as shown in FIG. 6.

FIG. 6 illustrates an interface 600 for viewing a verified record, in accordance with an embodiment. The interface 600 is a GUI that may be provided by the interface 250 of the computing system 110. For example, the interface 600 may be a pop-up window that is overlaid over the portal 500 upon a user selection of the flag 520. The interface 600 may be used by an organization client administrator to view a record provided by an end user and to view which verification criteria that the record meets. The interface 600 includes a copy of the documentation record 610 and a list 620 of verification criteria that the record 610 has met. In some embodiments, the verification criteria may be the same as one or more fields that are identified by the computer server 110 to be verified and after verification, caused to be displayed at a graphical user interface that allows the organization client to manage real-time transactions and view the transactions that are verified. In the example shown in FIG. 6, the record 610, an image of a paper receipt of a purchase from the merchant “Bookstore” for an amount of $95.67 on the date of Sep. 26, 2021, has been matched against the same merchant name, amount, and date of a transaction incurred by the same end user who uploaded the record 610. Thus, the computing server 110 has verified all three selection criteria in the list 620 for the record 610.

FIG. 7 illustrates a verification setting portal 700, in accordance with an embodiment. The portal 700 is a GUI that may be provided by the interface 250 of the computing system 110. The portal 700 includes various input elements for a user (e.g., an organization client administrator) to specify a selection criteria for which transactions and their corresponding documentation records need to be verified by the computing server 110. The portal 700 includes a notification 710 and a selection criteria input entry 720, where the input entry 720 further includes a requirement level input field 721, a transaction condition input field 722, and a transaction amount input field 723. The notification 710 informs an administrator of a number of transaction accounts for which settings specified through the portal 700 affect. In this example, nine hundred and eight transaction accounts are subject to the selection criteria specified through the portal 700. The input entry 720 is used to set a selection criteria for which transactions and corresponding documentation records are to be verified by the computing server 110. In this example, records are required for transactions above 75 dollars. The requirement level input field 721 may be a dropdown menu allowing the administrator to select from options such as “required” and “not required.” The transaction condition input field 722 may be a dropdown menu allowing the administrator to select options such as “transactions above,” “transactions equivalent to,” or “transactions below.” The transaction amount input field 723 may be an editable text input field allowing the administrator to enter a dollar amount. The computing server 110 receives the administrator's input in the portal 700 and generates selection criteria which the computing server 110 uses to identify real-time transactions as unverified transactions.

### Machine Learning Models

The computing server 110 may use machine learning models to identify third-party named entities and/or parse transaction information from documentation records (e.g., text recognition in images of receipts). One or more machine learning models may be part of the parsing model 246. The computing server 110 may accumulate a large number of past documentation records with different third-party named entities or transaction accounts of organization clients. The computing server 110 may use the past documentation records as a set of training samples to iteratively train one or more machine learning models that can be used to parse documentation records for transaction information (e.g., date of transaction, amount of transaction, a name of a third-party named entity, etc.). The computing server 110 may also generate another set of training samples to iteratively train other machine learning models that can be used to identify categories of third-party named entities. The parsing model 246 may use OCR to recognize text in an image of a physical documentation record and uses text recognition technique such as word embedding to identify useful transaction information in the documentation record.

A training sample may include a label for supervised training. The label may be generated by a manual process or by an automatic process. For example, in training a model that is used to parse a documentation record, the training samples may include past documentation records with the transaction data (e.g., a name of a third-party named entity) as labels. In some embodiments, a machine learning model may also be used to identify the useful fields in a documentation record. In such cases, the labels of training samples may be locations of the fields. In some embodiments, certain common documentation records may have rule-based models to help identifying information. For example, for common large merchants such as chain restaurants, online retailing platforms, large payment POS services, the documentation records of those merchants may follow a standard format. A rule-based model may be used to locate the standard fields in those records. In some cases, part of the training samples includes labels while other training samples do not include labels but are grouped with labeled samples through a process such as clustering and word embeddings.

In various embodiments, a wide variety of machine learning techniques may be used. Examples of which include different forms of unsupervised learning, clustering, embeddings such as word embeddings, support vector regression (SVR) model, random forest classifiers, support vector machines (SVMs) such as kernel SVMs, gradient boosting, linear regression, logistic regression, and other forms of regressions. Deep learning techniques such as neural networks, including convolutional neural networks (CNN), recurrent neural networks (RNN), and long short-term memory networks (LSTM), may also be used. Each transaction dataset may be converted to a feature vector that includes different dimensions. By way of example, strings in the transaction data may be converted to word embeddings using known techniques Word2Vec or another technique. The word embeddings can be one or more dimensions of the feature vector. Other data fields may be turned into various dimensions of a feature vector representing a transaction data. The feature vectors can be inputted into the machine learning model to iteratively train the machine learning model. A series of transactions may also be converted to a time series.

In various embodiments, the training techniques for iteratively training a machine learning model may be supervised, semi-supervised, or unsupervised. In supervised training, the machine learning algorithms may be trained with a set of training samples that are labeled. For example, a past transaction data can be associated with a label. The labels for each training sample may be binary or multi-class. In some cases, an unsupervised learning technique may be used. The samples used in training are not labeled. Various unsupervised learning techniques such as clustering may be used. In some cases, the training may be semi-supervised with the training set having a mix of labeled samples and unlabeled samples.

A machine learning model is associated with an objective function, which generates a metric value that describes the objective goal of the training process. For example, the training intends to reduce the error rate of the model in generating predictions of the results (whether the result is the identity of a merchant in one model, the transaction amount in a documentation receipt, the location of a field in an image of a physical receipt). In such a case, the objective function may monitor the error rate of the machine learning model. In transaction series analysis, the objective function of the machine learning algorithm may be the value different in predicting the recurring frequency in a training set. Such an objective function may be called a loss function. Other forms of objective functions may also be used, particularly for unsupervised learning models whose error rates are not easily determined due to the lack of labels. In various embodiments, the error rate may be measured as cross-entropy loss, L1 loss (e.g., the absolute distance between the predicted value and the actual value), L2 loss (e.g., root mean square distance).

Referring to FIG. 8, a structure of an example neural network (NN) is illustrated, according to an embodiment. While the structure of a neural network is illustrated as an example, the machine learning model may also be another model such as an SVM, a random forest model, or another suitable model. The NN 800 may receive an input 810 and generate an output 820. The NN 800 may include different kinds of layers, such as convolutional layers 830, pooling layers 840, recurrent layers 850, full connected layers 860, and custom layers 870. A convolutional layer 830 convolves the input of the layer with one or more kernels to generate convolved features. Each convolution result may be associated with an activation function. A convolutional layer 830 may be followed by a pooling layer 840 that selects the maximum value (max pooling) or average value (average pooling) from the portion of the input covered by the kernel size. The pooling layer 840 reduces the spatial size of the extracted features. In some embodiments, a pair of convolutional layer 830 and pooling layer 840 may be followed by a recurrent layer 850 that includes one or more feedback loop 855. The recurrent layer 850 may be gated in the case of an LSTM. The recurrent layer 850 may be particularly useful in analyzing series such as a transaction series. The layers 830, 840, and 850 may be followed in multiple fully connected layers 860 that have nodes (represented by squares in FIG. 8) connected to each other. The fully connected layers 860 may be used for classification and object identification. In one embodiment, one or more custom layers 870 may also be presented for the generation of a specific format of output 820.

The order of layers and the number of layers of the NN 800 in FIG. 8 is for example only. In various embodiments, a NN 800 includes one or more convolutional layer 830 but may or may not include any pooling layer 840 or recurrent layer 850. If a pooling layer 840 is present, not all convolutional layers 830 are always followed by a pooling layer 840. A recurrent layer may also be positioned differently at other locations of the NN. For each convolutional layer 830, the sizes of kernels (e.g., 3×3, 5×5, 7×7, etc.) and the numbers of kernels allowed to be learned may be different from other convolutional layers 830. In some embodiments, the NN 800 does not include any convolutional layers.

A machine learning model includes certain layers, nodes, kernels, and/or coefficients. Training of a machine learning model, such as the NN 800, includes iterations of forward propagation and backpropagation. Each layer in a neural network may include one or more nodes, which may be fully or partially connected to other nodes in adjacent layers. In forward propagation, the neural network performs the computation in the forward direction based on outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Each of the functions in the neural network may be associated with different coefficients (e.g. weights and kernel coefficients) that are adjustable during training. In addition, some of the nodes in a neural network may each also be associated with an activation function that decides the weight of the output of the node in forward propagation. Common activation functions may include step functions, linear functions, sigmoid functions, hyperbolic tangent functions (tanh), and rectified linear unit functions (ReLU). After input is provided into the neural network and passes through a neural network in the forward direction, the results may be compared to the training labels or other values in the training set to determine the neural network's performance. The process of prediction may be repeated for other transactions in the training sets to compute the value of the objective function in a particular training round. In turn, the neural network performs backpropagation by using gradient descent such as stochastic gradient descent (SGD) to adjust the coefficients in various functions to improve the value of the objective function.

Multiple iterations of forward propagation and backpropagation may be performed. Training may be completed when the objective function has become sufficiently stable (e.g., the machine learning model has converged) or after a predetermined number of rounds for a particular set of training samples. Different machine learning models may be trained for different purposes. The machine learning models may be used in the transaction analysis engine 240. For example, a trained machine learning model for determining transaction data in a documentation record may be used by the record parser 242 (e.g., operation 312 in the process 300).

### Additional Considerations

The general architecture disclosed herein has applications in various areas, such as a payment transaction verification process. For example, in a credit card transaction, the credit card company logs data for the transaction incurred between an end user and a merchant, and the merchant provides a record of the transaction to the end user. This record can be a receipt such as an emailed receipt or a printed receipt. In one embodiment, a computing server verifies the transactions by matching transaction data (e.g., amount of the transaction, date of the transaction, and name of the merchant) provided by the credit card company against the transaction data parsed from a receipt. Instead of prompting the end user to provide the receipt for verification, the computing server can operate on standby until, unprompted, the end user provides the receipt. Thus, the computing server does not expend unnecessary processing and network bandwidth resources to acquire records from end users for verifying transactions.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Embodiments according to the invention are in particular disclosed in the attached claims directed to a method and a computer program product, wherein any feature mentioned in one claim category, e.g. method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject-matter which can be claimed comprises not only the combinations of features as set out in the disclosed embodiments but also any other combination of features from different embodiments. Various features mentioned in the different embodiments can be combined with explicit mentioning of such combination or arrangement in an example embodiment. Furthermore, any of the embodiments and features described or depicted herein can be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In one embodiment, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed by the specific order claimed or described in the disclosure. Some steps may be performed before others even though the other steps are claimed or described first in this disclosure.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A computer-implemented method, comprising:
receiving one or more selection criteria from an organization client, the selection criteria specifying transactions that need to be verified;
processing real-time transactions on behalf of the organization client, each of the real-time transactions incurred between a third-party named entity and a transaction account associated with the organization client;
identifying one or more of the real-time transactions as unverified transactions using the selection criteria specified by the organization client, each of the unverified transactions including one or more fields that need to be verified;
receiving, through a communication channel and from an end user associated with the organization client, a forward of a documentation record that is automatically generated by a particular third-party named entity acknowledging an occurrence of a particular real-time transaction;
parsing information in the documentation record;
identifying an unverified transaction that matches the information parsed from the documentation record;
matching the information parsed from the documentation record to data in the unverified transaction to identify one or more fields that are verified; and
causing a graphical user interface that allows the organization client to manage the real-time transactions to display that the one or more fields in the particular real-time transaction are verified.

2. The computer-implemented method of claim 1, wherein the documentation record is an image of a physical receipt of the particular real-time transaction.

3. The computer-implemented method of claim 2, wherein parsing information in the documentation record comprises:
applying a machine learning model to the image, the machine learning model trained, using a plurality of images of physical receipts of past transactions, to identify the one or more fields that need to be verified in the documentation record.

4. The computer-implemented method of claim 1, wherein the documentation record is an email receipt generated by the particular third-party named entity and the forward is an email forward by the end user forwarding the email receipt.

5. The computer-implemented method of claim 4, wherein the end user is a first end user and the transaction account is assigned to a second end user, and identifying the unverified transaction comprises:
identifying a message heading in the email receipt;
determining, using the message heading, that the email receipt was transmitted from the second end user to the first end user; and
identifying a set of transactions incurred between a plurality of third-party named entities and the transaction account, wherein the set of transactions include the unverified transaction using the electronic address of the first end user.

6. The computer-implemented method of claim 4, wherein the transaction account is assigned to the end user, and identifying the unverified transaction comprises:
identifying an absence of a message heading in the email receipt;
determining, using an email address of the end user, that the end user is associated with the organization client; and
determining a set of transactions incurred between a plurality of third-party named entities and the transaction account within a duration of time, the set of unverified transactions including the unverified transaction.

7. The computer-implemented method of claim 1, wherein the organization client is a first organization client, wherein the end user is further associated with a second organization client, wherein the real-time transactions are a first plurality of real-time transactions,
wherein receiving, through the communication channel and from the end user associated with the first organization client, the forward of the documentation record comprises:
receiving the forward through a software-as-a-service (SaaS) platform comprising a user interface accessible by end users associated with the first organization client, wherein the communication channel comprises the SaaS platform, and
wherein identifying the unverified transaction comprises:
identifying a mapping of the end user to both the transaction account associated with the first organization client and a transaction account associated with the second organization client; and
in response to identifying the mapping:
accessing a second plurality of real-time transactions processed on behalf of the second organization client, and
identifying a set of transactions from the second plurality of real-time transactions, the set of transactions incurred between a plurality of third-party named entities and the transaction account associated with the second organization client, the set of processed real-time transaction including the unverified transaction.

8. The computer-implemented method of claim 1, wherein the one or more selection criteria further specifies a plurality of transaction accounts with which transactions incurred are to be verified.

9. The computer-implemented method of claim 1, wherein the one or more fields that need to be verified include an amount of the unverified transaction, a date of the unverified transaction, or a name of the third-party named entity of the unverified transaction.

10. The computer-implemented method of claim 1, wherein processing real-time transactions on behalf of the organization client comprises:
receiving a noisy string of the name of the third-party named entity of the unverified transaction, wherein the noisy string includes a string irrelevant to the name;
determining, using a named entity identification rule, the noisy string of the name represents the third-party named entity; and
updating a transaction data structure of the real-time transactions to include an entry for the unverified transaction, the entry including the name of the third-party named entity.

11. The computer-implemented method of claim 1, wherein the communication channel comprises one or more of a short message service (SMS) message, email, or a SaaS platform.

12. The computer-implemented method of claim 1, further comprising:
causing the graphical user interface to display one or more user input fields configured to receive manual verification from the organization client that the one or more fields are present in the documentation record.

13. A non-transitory computer-readable storage medium configured to store computer code comprising instructions, the instructions, when executed by one or more processors, cause the one or more processors to:
receive one or more selection criteria from an organization client, the selection criteria specifying transactions that need to be verified;
process real-time transactions on behalf of the organization client, each of the real-time transactions incurred between a third-party named entity and a transaction account associated with the organization client;
identify one or more of the real-time transactions as unverified transactions using the selection criteria specified by the organization client, each of the unverified transactions including one or more fields that need to be verified;
receive, through a communication channel and from an end user associated with the organization client, a forward of a documentation record that is automatically generated by a particular third-party named entity acknowledging an occurrence of a particular real-time transaction;
parse information in the documentation record;
identify an unverified transaction that matches the information parsed from the documentation record;
match the information parsed from the documentation record to data in the unverified transaction to identify one or more fields that are verified; and
cause a graphical user interface that allows the organization client to manage the real-time transactions to display that the one or more fields in the particular real-time transaction are verified.

14. The non-transitory computer-readable storage medium of claim 13, wherein the documentation record is an image of a physical receipt of the particular real-time transaction.

15. The non-transitory computer-readable storage medium of claim 14, wherein the instruction for parsing information in the documentation record comprises instructions that, when executed by the one or more processors, cause the one or more processors to:
apply a machine learning model to the image, the machine learning model trained, using a plurality of images of physical receipts of past transactions, to identify the one or more fields that need to be verified in the documentation record.

16. The non-transitory computer-readable storage medium of claim 13, wherein the documentation record is an email receipt generated by the particular third-party named entity and the forward is an email forward by the end user forwarding the email receipt.

17. The non-transitory computer-readable storage medium of claim 16, wherein the end user is a first end user and the transaction account is assigned to a second end user, and the instruction for identifying the unverified transaction comprises instructions that, when executed by the one or more processors, cause the one or more processors to:
identify a message heading in the email receipt;
determine, using the message heading, that the email receipt was transmitted from the second end user to the first end user; and
identify a set of transactions incurred between a plurality of third-party named entities and the transaction account, wherein the set of transactions include the unverified transaction using the electronic address of the first end user.

18. The non-transitory computer-readable storage medium of claim 16, wherein the transaction account is assigned to the end user, and wherein the instruction for identifying the unverified transaction comprises instructions that, when executed by the one or more processors, cause the one or more processors to:
identify an absence of a message heading in the email receipt;
determine, using an email address of the end user, that the end user is associated with the organization client; and
determine a set of transactions incurred between a plurality of third-party named entities and the transaction account within a duration of time, the set of unverified transactions including the unverified transaction.

19. The non-transitory computer-readable storage medium of claim 13, wherein the organization client is a first organization client, wherein the end user is further associated with a second organization client, wherein the real-time transactions are a first plurality of real-time transactions,
wherein the instruction for receiving, through the communication channel and from the end user associated with the first organization client, the forward of the documentation record comprises instructions that, when executed by the one or more processors, cause the one or more processors to:
receive the forward through a software-as-a-service (SaaS) platform comprising a user interface accessible by end users associated with the first organization client, wherein the communication channel comprises the SaaS platform, and
wherein the instruction for identifying the unverified transaction comprises instructions that, when executed by the one or more processors, cause the one or more processors to:
identify a mapping of the end user to both the transaction account associated with the first organization client and a transaction account associated with the second organization client; and
in response to identifying the mapping:
access a second plurality of real-time transactions processed on behalf of the second organization client, and
identify a set of transactions from the second plurality of real-time transactions, the set of transactions incurred between a plurality of third-party named entities and the transaction account associated with the second organization client, the set of processed real-time transaction including the unverified transaction.

20. A system, comprising:
one or more processors; and
memory configured to store instructions, the instructions, when executed by the one or more processors, cause the one or more processors to:
receive one or more selection criteria from an organization client, the selection criteria specifying transactions that need to be verified;
process real-time transactions on behalf of the organization client, each of the real-time transactions incurred between a third-party named entity and a transaction account associated with the organization client;
identify one or more of the real-time transactions as unverified transactions using the selection criteria specified by the organization client, each of the unverified transactions including one or more fields that need to be verified;
receive, through a communication channel and from an end user associated with the organization client, a forward of a documentation record that is automatically generated by a particular third-party named entity acknowledging an occurrence of a particular real-time transaction;
parse information in the documentation record;
identify an unverified transaction that matches the information parsed from the documentation record;
match the information parsed from the documentation record to data in the unverified transaction to identify one or more fields that are verified; and
cause a graphical user interface that allows the organization client to manage the real-time transactions to display that the one or more fields in the particular real-time transaction are verified.
